(19) United States
(12) Patent Application Publication
(10) Pub. No.: US 2019/0087022 A1
(43) Pub. Date: Mar. 21, 2019

(54) MOUSE DEVICE

(71) Applicant: Cheng Uei Precision Industry Co., Ltd., New Taipei City (TW)

(72) Inventors: CHI-MING TSENG, New Taipei City (TW); YU-HSIANG TING, New Taipei City (TW)

(21) Appl. No.: 15/706,705

(22) Filed: Sep. 16, 2017

(51) Int. Cl. G06F 3/0354; G06F 3/01

(52) U.S. Cl. CPC G06F 3/03543; G06F 3/016

(57) ABSTRACT

A mouse device includes a shell, a circuit board assembled in the shell, more than one button disposed to the shell, and more than one electronic switch. The more than one electronic switch is assembled on the circuit board which is assembled in the shell and is electrically connected with the circuit board. The more than one electronic switch is corresponding to the more than one button. The more than one button is capable of contacting and pressing the more than one electronic switch. A top surface of the more than one electronic switch is perpendicular to a direction of a finger pressing downward on a top surface of the more than one button.

### BACKGROUND OF THE INVENTION

### 1. Field of the Invention

The present invention generally relates to a mouse device, and more particularly to a mouse device effectively improving a utilization efficiency of a force exerted by a finger.

### 2. The Related Art

As known to all, a mouse device is used for operating various functions which include a function of inputting coordinates, a function of clicking on objects, a function of scrolling pages and so on.

Referring to FIG. 6, a conventional mouse device 100′ generally includes a shell 11′, a circuit board 12′ disposed in the shell 11′, more than one electronic switch 13′ electrically connected with and fastened on the circuit board 12′, and more than one button 14′ disposed to the shell 11′ and corresponding to the more than one electronic switch 13′. When a user operates the conventional mouse device 100′ in a general way, a palm is put on or adhered to a top surface 111′ of the shell 11′ and the more than one button 14′ is pressed by a tail end of a finger (such as a tail end of an index finger or a middle finger) of the user, so that the more than one button 14′ contacts and presses the more than one electronic switch 13′ for triggering the conventional mouse device 100′. Because the top surface 111′ of the shell 11′ is of a curved surface, when the user operates the conventional mouse device 100′ actually, the finger presses on a top surface of the more than one button 14′, the finger will inertially exert a force on the top surface of the more than one button 14′ in a direction perpendicular to a tangential direction of the top surface of the more than one button 14′.

However, a direction of the more than one electronic switch 13′ of the conventional mouse device 100′ being assembled on the circuit board 12′ is perpendicular to the circuit board 12′, namely, an angle is generated between the direction of the finger exerting the force on the top surface of the more than one button 14′ and a direction of a downward pressing force exerted on the more than one electronic switch 13′ by the more than one button 14′, so that an actual force of pressing downward on the more than one electronic switch 13′ exerted by the more than one button 14′ is smaller than the force exerted on the top surface of the more than one button 14′ by the finger that affects a utilization efficiency of the force exerted by the finger. Moreover, when the conventional mouse device 100′ is used as an electronic sports (E-sports) mouse in a game or a match, an effective force exerted on the top surface of the more than one button 14′ by the finger will be keys of both a success and a failure of the game or the match, so if the utilization efficiency of the force exerted by the finger is affected, a success rate of the game or the match will be affected.

Thus, in order to solve the problem described above, an innovative mouse device is essential to be designed, the innovative mouse device effectively improves a utilization efficiency of a force exerted by a finger.

### SUMMARY OF THE INVENTION

An object of the present invention is to provide a mouse device effectively improving a utilization efficiency of a force exerted by a finger. The mouse device includes a shell, a circuit board assembled in the shell, more than one button disposed to the shell, and more than one electronic switch. The more than one electronic switch is assembled on the circuit board which is assembled in the shell and is electrically connected with the circuit board. The more than one electronic switch is corresponding to the more than one button. The more than one button is capable of contacting and pressing the more than one electronic switch. A top surface of the more than one electronic switch is perpendicular to a direction of the finger pressing downward on a top surface of the more than one button.

Another object of the present invention is to provide a mouse device. The mouse device includes a shell, a circuit board assembled in the shell, more than one button disposed to the shell, more than one receiving base, and more than one electronic switch. The more than one receiving base is assembled to the circuit board and is disposed corresponding to the more than one button. An upper portion of the more than one receiving base opens a receiving space penetrating through a top surface of the more than one receiving base. The more than one electronic switch is received in the receiving space. The more than one button is capable of contacting and pressing the more than one electronic switch. A top surface of the more than one electronic switch is perpendicular to a direction of the finger pressing downward on a top surface of the more than one button.

As described above, a top surface of the more than one electronic switch has an inclined angle with respect to the circuit board to make the top surface of the more than one electronic switch perpendicular to the direction of the finger pressing downward on the top surface of the more than one button, when a user controls the mouse device, the finger presses downward on the top surface of the more than one button, the movement direction of the more than one electronic switch is perpendicular to the tangential direction of the top surface of the more than one button, a direction of the force of pressing downward on the top surface of the more than one button exerted by the finger is the same as the movement direction of the more than one electronic switch, so that the force of pressing downward on the top surface of the more than one button exerted by the finger is effectively transmitted to the more than one electronic switch. As a result, the mouse device effectively improves a utilization efficiency of the force exerted by the finger. Moreover, when the mouse device is used as an electronic sports (E-sports) mouse in a game or a match, the effective force exerted on the top surface of the more than one button by the finger will be keys of both a success and a failure of the game or the match, so if the utilization efficiency of the force exerted by the finger is affected, a success rate of the game or the match will be affected.

### BRIEF DESCRIPTION OF THE DRAWINGS

The present invention will be apparent to those skilled in the art by reading the following description, with reference to the attached drawings, in which:

FIG. 1 is a diagrammatic drawing of a mouse device in accordance with a first preferred embodiment of the present invention, wherein more than one button of the mouse device is pressed by a user;

FIG. 2 is a diagrammatic drawing of the mouse device in accordance with a second preferred embodiment of the present invention, wherein the more than one button of the mouse device is pressed by the user;

FIG. 3 is an enlarged view of an encircled portion III of the mouse device of FIG. 2;

FIG. 4 is a diagrammatic drawing of the mouse device in accordance with a third preferred embodiment of the present invention, wherein the more than one button of the mouse device is pressed by the user;

FIG. 5 is a diagrammatic drawing of the mouse device in accordance with a fourth preferred embodiment of the present invention, wherein the more than one button of the mouse device is pressed by the user; and

FIG. 6 is a diagrammatic drawing of a conventional mouse device in prior art, wherein more than one button of the conventional mouse device is pressed by a user.

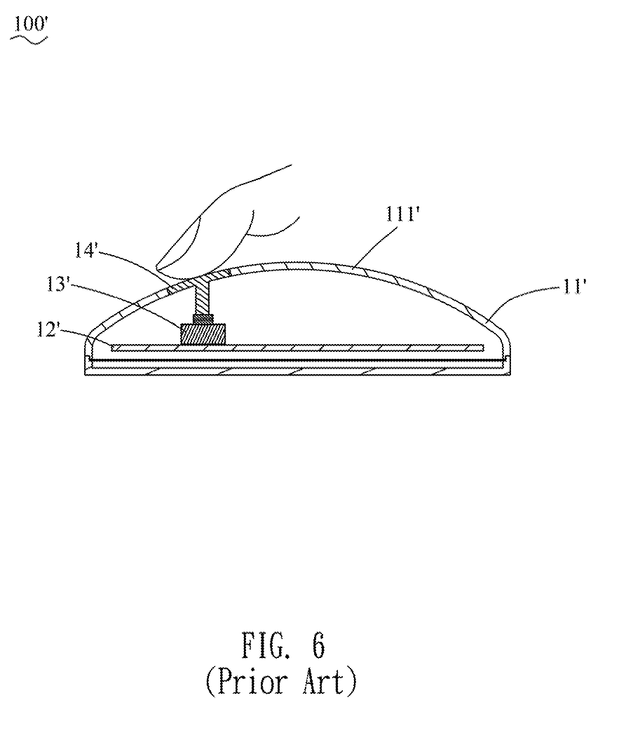

### DETAILED DESCRIPTION OF THE PREFERRED EMBODIMENT

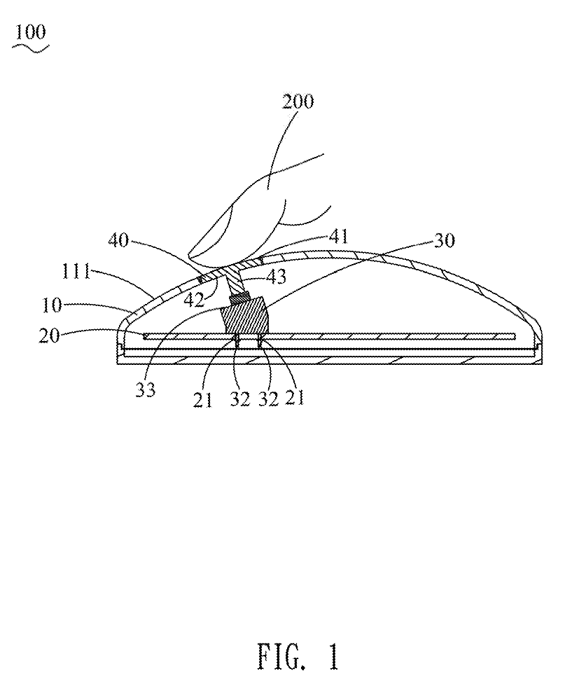

With reference to FIG. 1 to FIG. 5, a mouse device 100 in accordance with a first preferred embodiment, a second preferred embodiment, a third preferred embodiment and a fourth preferred embodiment of the present invention is shown. The mouse device 100 includes a shell 10, a circuit board 20, more than one electronic switch 30, and more than one button 40 capable of contacting and pressing the more than one electronic switch 30. The more than one button 40 is disposed to the shell 10. The circuit board 20 is assembled in the shell 10. The more than one electronic switch 30 is assembled in the shell 10 and is corresponding to the more than one button 40. The circuit board 20 is equipped with multiple electronic components (not shown) needed by an operation of the mouse device 100.

A top surface 111 of the shell 10 is of an arc shape. The more than one button 40 has an arc-shaped pressing portion 42, and a connecting portion 43 protruded towards the more than one electronic switch 30 from a bottom surface of the pressing portion 42. When a user controls the mouse device 100, a palm of the user is put on or adhered to the top surface 111 of the shell 10, and a tail end of a finger 200 (such as a tail end of an index finger or a middle finger) of the user is pressed downward on a top surface 41 of the more than one button 40, the connecting portion 43 of the more than one button 40 contacts and presses the more than one electronic switch 30, so that the more than one button 40 contacts and presses the more than one electronic switch 30 for triggering the mouse device 100. A top surface 33 of the more than one electronic switch 30 is perpendicular to a direction of the finger 200 pressing downward on the top surface 41 of the more than one button 40, so that a direction of a force of pressing downward on the top surface 41 of the more than one button 40 exerted by the finger 200 is perpendicular to the top surface 33 of the more than one electronic switch 30.

Referring to FIG. 1, in the first preferred embodiment, the more than one electronic switch 30 is assembled on the circuit board 20 which is assembled in the shell 10 and is electrically connected with the circuit board 20. The top surface 33 of the more than one electronic switch 30 has an inclined angle with respect to the circuit board 20, so the top surface 33 of the more than one electronic switch 30 is perpendicular to a direction of the finger 200 pressing downward on the top surface 41 of the more than one button 40. Two portions of the circuit board 20 open two perforations 21. A bottom surface of the more than one electronic switch 30 is equipped with two electrical pins 32. The two electrical pins 32 are inserted into the two perforations 21, respectively.

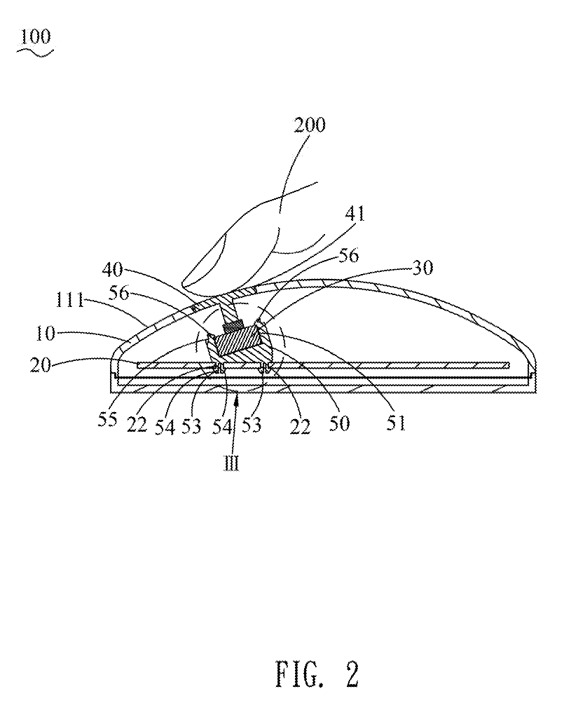

Referring to FIG. 2 to FIG. 5, in the second preferred embodiment, the third preferred embodiment and the fourth preferred embodiment, the mouse device 100 further includes more than one receiving base 50. The more than one receiving base 50 is assembled to the circuit board 20 and is disposed corresponding to the more than one button 40. An upper portion of the more than one receiving base 50 opens a receiving space 51 penetrating through a top surface 55 of the more than one receiving base 50. The more than one electronic switch 30 is received in the receiving space 51 of the more than one receiving base 50. The receiving space 51 of the more than one receiving base 50 has an inclined angle with respect to the circuit board 20 to make the top surface 33 of the more than one electronic switch 30 have the inclined angle with respect to the circuit board 20, so the top surface 33 of the more than one electronic switch 30 is perpendicular to the direction of the finger 200 pressing downward on the top surface 41 of the more than one button 40, and the receiving space 51 of the more than one receiving base 50 is perpendicular to the direction of the finger 200 pressing downward on the top surface 41 of the more than one button 40.

Referring to FIG. 2 to FIG. 5 again, the circuit board 20 opens at least one fastening hole 22. A bottom surface of the more than one receiving base 50 defines at least one fastening portion 53 corresponding to the at least one fastening hole 22. The more than one receiving base 50 is assembled to the circuit board 20 by way of the at least one fastening portion 53 being locked in at least one fastening hole 22. The at least one fastening portion 53 is at least one bolt (not shown) or at least one buckling hook (not shown). Specifically, two lower portions of two side surfaces of the at least one fastening portion 53 are defined as two guiding surfaces 54 inclined inward and downward. The at least one fastening portion 53 is guided by the two guiding surfaces 54. The at least one fastening portion 53 passes through and is locked in the at least one fastening hole 22, so that the more than one receiving base 50 is fastened to the circuit board 20. Preferably, the circuit board 20 opens two fastening holes 22. The bottom surface of the more than one receiving base 50 defines two fastening portions 53 corresponding to the two fastening holes 22, respectively. Two lower portions of two side surfaces of each of the two fastening portions 53 are defined as the two guiding surfaces 54 inclined inward and downward. The two fastening portions 53 are guided by the guiding surfaces 54 of the two fastening portions 53. The two fastening portions 53 pass through and are locked in the two fastening holes 22, respectively.

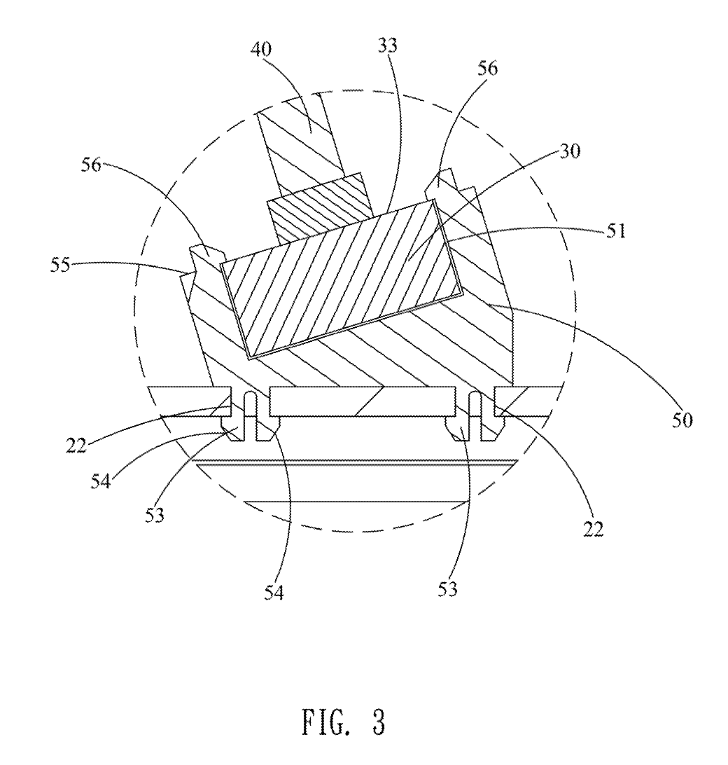

Referring to FIG. 2 and FIG. 3, in the second preferred embodiment, two opposite sides of the top surface of the more than one receiving base 50 protrude upward and then towards each other to form two blocking portions 56. The two blocking portions 56 block the top surface 33 of the more than one electronic switch 30.

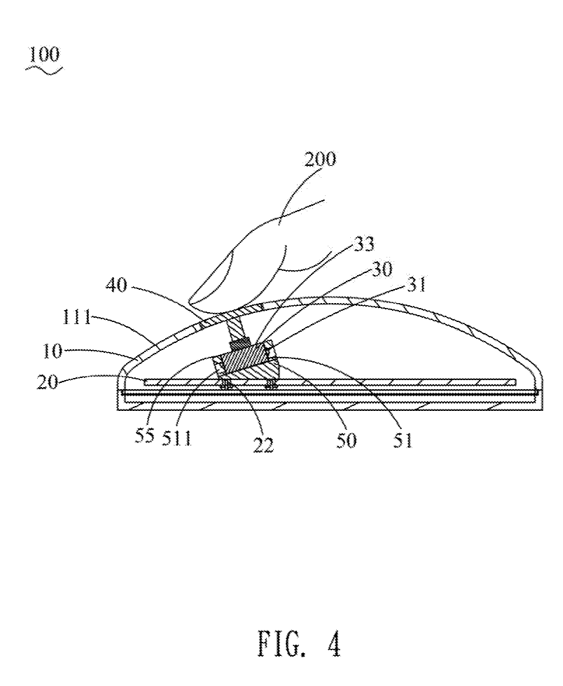

Referring to FIG. 4, in the third preferred embodiment, the more than one electronic switch 30 is fastened to the more than one receiving base 50 by way of the more than one electronic switch 30 and the more than one receiving base 50 being buckled with each other. Specifically, two sides of the more than one electronic switch 30 protrude towards opposite directions to form two buckling portions 31. Two side walls of the receiving space 51 of the more than one receiving base 50 open two buckling grooves 511 penetrating through inner surfaces of the two side walls of the receiving space 51. The two buckling grooves 511 are corresponding to the two buckling portions 31, respectively. The two buckling portions 31 are buckled in and fastened to the two buckling grooves 511, respectively.

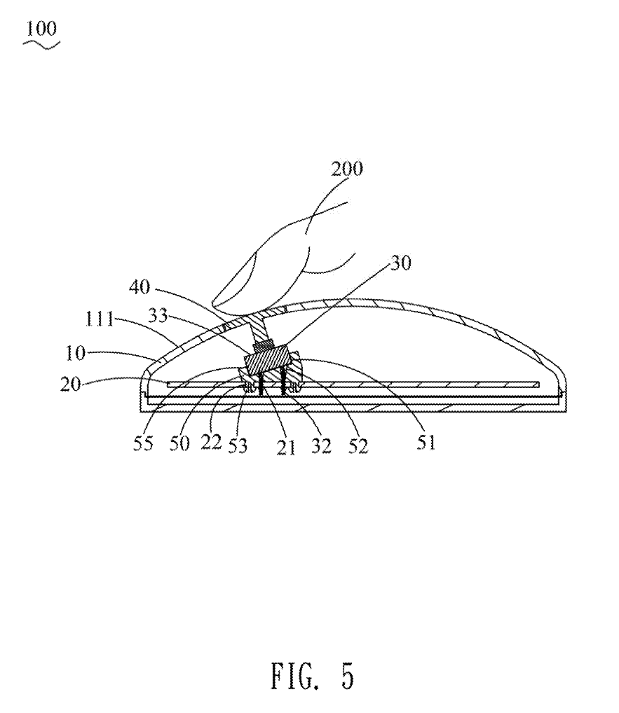

Referring to FIG. 5, in the fourth preferred embodiment, two sides of a bottom surface of the more than one electronic switch 30 are equipped with two electrical pins 32 electrically connected with the circuit board 20. Two sides of a lower portion of the more than one receiving base 50 open two inserting grooves 52 extending upward to the receiving space 51 and penetrating downward through a bottom surface of the more than one receiving base 50. The two inserting grooves 52 are communicated with the receiving space 51. Each of the two inserting grooves 52 is shown as a funnel shape. The two electrical pins 32 pass through the two inserting grooves 52 respectively to be electrically connected with the circuit board 20. The two electrical pins 32 passing through the two inserting grooves 52 are inserted into the two perforations 21, respectively.

Referring to FIG. 1 to FIG. 5, so, in the first preferred embodiment, the second preferred embodiment, the third preferred embodiment and the fourth preferred embodiment, when the user controls the mouse device 100, the finger 200 presses downward on the top surface 41 of the more than one button 40. A movement direction of the more than one electronic switch 30 is perpendicular to a tangential direction of the top surface 41 of the more than one button 40. So that the direction of the force of pressing downward on the top surface 41 of the more than one button 40 exerted by the finger 200 is the same as the movement direction of the more than one electronic switch 30.

As described above, the top surface 33 of the more than one electronic switch 30 has the inclined angle with respect to the circuit board 20 to make the top surface 33 of the more than one electronic switch 30 perpendicular to the direction of the finger 200 pressing downward on the top surface 41 of the more than one button 40, when the user controls the mouse device 100, the finger 200 presses downward on the top surface 41 of the more than one button 40, the movement direction of the more than one electronic switch 30 is perpendicular to the tangential direction of the top surface 41 of the more than one button 40, the direction of the force of pressing downward on the top surface 41 of the more than one button 40 exerted by the finger 200 is the same as the movement direction of the more than one electronic switch 30, so that the force of pressing downward on the top surface 41 of the more than one button 40 exerted by the finger 200 is effectively transmitted to the more than one electronic switch 30. As a result, the mouse device 100 effectively improves a utilization efficiency of the force exerted by the finger 200. Moreover, when the mouse device 100 is used as an electronic sports (E-sports) mouse in a game or a match, the effective force exerted on the top surface 41 of the more than one button 40 by the finger will be keys of both a success and a failure of the game or the match, so if the utilization efficiency of the force exerted by the finger is affected, a success rate of the game or the match will be affected.

What is claimed is:

1. A mouse device, comprising:
a shell;
a circuit board assembled in the shell;
more than one button disposed to the shell; and
more than one electronic switch assembled on the circuit board which is assembled in the shell and electrically connected with the circuit board, the more than one electronic switch being corresponding to the more than one button, the more than one button capable of contacting and pressing the more than one electronic switch, a top surface of the more than one electronic switch being perpendicular to a direction of a finger pressing downward on a top surface of the more than one button.

2. The mouse device as claimed in claim 1, wherein the top surface of the more than one electronic switch has an inclined angle with respect to the circuit board, so that a direction of a force of pressing downward on the top surface of the more than one button exerted by the finger is perpendicular to the top surface of the more than one electronic switch.

3. The mouse device as claimed in claim 1, wherein two portions of the circuit board open two perforations, a bottom surface of the more than one electronic switch is equipped with two electrical pins, the two electrical pins are inserted into the two perforations, respectively.

4. A mouse device, comprising:
a shell;
a circuit board assembled in the shell;
more than one button disposed to the shell;
more than one receiving base assembled to the circuit board and disposed corresponding to the more than one button, an upper portion of the more than one receiving base opening a receiving space penetrating through a top surface of the more than one receiving base; and
more than one electronic switch received in the receiving space, the more than one button capable of contacting and pressing the more than one electronic switch, a top surface of the more than one electronic switch being perpendicular to a direction of a finger pressing downward on a top surface of the more than one button.

5. The mouse device as claimed in claim 4, wherein the receiving space has an inclined angle with respect to the circuit board to make the top surface of the more than one electronic switch have the inclined angle with respect to the circuit board, so that the receiving space is perpendicular to the direction of the finger pressing downward on the top surface of the more than one button, so that a direction of a force of pressing downward on the top surface of the more than one button exerted by the finger is perpendicular to the top surface of the more than one electronic switch.

6. The mouse device as claimed in claim 4, wherein the more than one electronic switch is fastened to the more than one receiving base by way of the more than one electronic switch and the more than one receiving base being buckled with each other.

7. The mouse device as claimed in claim 6, wherein two sides of the more than one electronic switch protrude towards opposite directions to form two buckling portions, two side walls of the receiving space open two buckling grooves penetrating through inner surfaces of the two side walls of the receiving space, the two buckling grooves are corresponding to the two buckling portions, respectively, the two buckling portions are buckled in and fastened to the two buckling grooves, respectively.

8. The mouse device as claimed in claim 4, wherein two opposite sides of the top surface of the more than one receiving base protrude upward and then towards each other to form two blocking portions, the two blocking portions block the top surface of the more than one electronic switch.

9. The mouse device as claimed in claim 4, wherein two sides of a bottom surface of the more than one electronic switch are equipped with two electrical pins electrically connected with the circuit board, two sides of a lower portion of the more than one receiving base open two inserting grooves extending upward to the receiving space and penetrating downward through a bottom surface of the more than one receiving base, the two inserting grooves are communicated with the receiving space, the two electrical pins pass through the two inserting grooves respectively to electrically connected with the circuit board, two portions of the circuit board open two perforations, the two electrical pins passing through the two inserting grooves are inserted into the two perforations, respectively.

10. The mouse device as claimed in claim 9, wherein each of the two inserting grooves is shown as a funnel shape.

11. The mouse device as claimed in claim 4, wherein the circuit board opens at least one fastening hole, a bottom surface of the more than one receiving base define at least one fastening portion corresponding to the at least one fastening hole, the more than one receiving base is assembled to the circuit board by way of the at least one fastening portion being locked in at least one fastening hole.

12. The mouse device as claimed in claim 11, wherein the at least one fastening portion is at least one bolt.

13. The mouse device as claimed in claim 11, wherein the at least one fastening portion is at least one buckling hook.

14. The mouse device as claimed in claim 11, wherein the at least one fastening portion passes through and is locked in the at least one fastening hole.

15. The mouse device as claimed in claim 11, wherein two lower portions of two side surfaces of the at least one fastening portion are defined as two guiding surfaces inclined inward and downward, the at least one fastening portion is guided by the two guiding surfaces.

16. The mouse device as claimed in claim 4, wherein the circuit board opens two fastening holes, a bottom surface of the more than one receiving base define two fastening portions corresponding to the two fastening holes, respectively, the two fastening portions pass through and are locked in the two fastening holes, respectively.

17. The mouse device as claimed in claim 16, wherein two lower portions of two side surfaces of each of the two fastening portions are defined as two guiding surfaces inclined inward and downward, the two fastening portions are guided by the guiding surfaces of the two fastening portions.
